(19) United States
(12) Patent Application Publication
(10) Pub. No.: US 2013/0335724 A1
(43) Pub. Date: Dec. 19, 2013

(54) CONTINUOUS RANGE FINDER

(71) Applicants: Katrine MYGLAND, Kongsberg (NO); Vegard ALMAAS, Oslo (NO); Øyvind OVERREIN, Strommen (NO); Tom Kàre BORGE, Frogner (NO)

(72) Inventors: Katrine MYGLAND, Kongsberg (NO); Vegard ALMAAS, Oslo (NO); Øyvind OVERREIN, Strommen (NO); Tom Kàre BORGE, Frogner (NO)

(73) Assignee: KONGSBERG DEFENCE & AEROSPACE AS, Kongsberg (NO)

(21) Appl. No.: 13/495,153

(22) Filed: Jun. 13, 2012

(51) Int. Cl. G01C 3/08; G01C 1/00

(52) U.S. Cl. 356/4.01

(57) ABSTRACT

Method and system for obtaining continuous range measurements to a target aimed at by using a laser range finder, and where this is independent of whether a laser beam in the laser range finder is reflected off the target at all time.

### INTRODUCTION

The present invention comprises a method and system for range measurements based on continuous laser range measurements to static or moving targets and where that range measurements corresponding to line-of-sight obstructions, or to the background behind the target are discarded.

### BACKGROUND OF THE INVENTION

A Laser Range Finder (LRF) is a device which uses a laser beam to determine the distance to a moving or static object by non-contact means. The most common form of LRF operates on the Time of Flight (TOF) principle by sending a laser pulse in a narrow beam towards the object and measuring the time taken by the pulse to be reflected off the target and returned to the sender.

A LRF can be placed on a moving platform for continuously measuring ranges to moving targets. The moving platform can be gyro stabilized making it easier for an operator to keep a laser beam pointed at a target.

A problem with conventional laser range finders occurs when the laser beam misses a target. This may be due to obstructions of free sight between the laser beam and a target, resulting in a wrong distance measurement to the target. Another reason for missing the target is that an operator will not always be able to aim and keep the laser beam continuously on the target when performing continues laser range readings. In one moment the laser can hit a target and in a next moment the laser may hit the background. The laser beam may also partly cover the target and the background. In such cases the output from the LRF may return the range to both the target and the background. These two ranges will have the same time stamp, but only one range is the correct range to the target.

Use of a LRF requires robust and continuous range measurements to a target. This again, requires that the raw output from the laser range finder is processed such that range measurements corresponding to line-of-sight obstructions, or to the background behind the target are removed.

The present invention is related to how an operator interface unit and a signal processing unit are facilitating these features based on the use of the LRF.

### OBJECTS AND SUMMARY OF THE INVENTION

The object of the present invention is to provide a method and system for obtaining continuous range measurements to a target aimed at by using a laser range finder, and where this is independent of whether a laser beam in the laser range finder is reflected off the target at all time.

The method comprises the steps of:
directing the laser beam at the target;
continuously receiving range measurements to the target together with measurements of angular position of said laser beam;
processing said range and angular position measurements by applying multiple target tracking, and
presenting continuous range measurements to the target independently of whether the laser beam in the laser range finder is pointing on the target at all time.

The system comprises means for performing said method.

The present invention is defined in the main claims, and additional features are defined in the dependent claims.

### DETAILED DESCRIPTION OF THE INVENTION

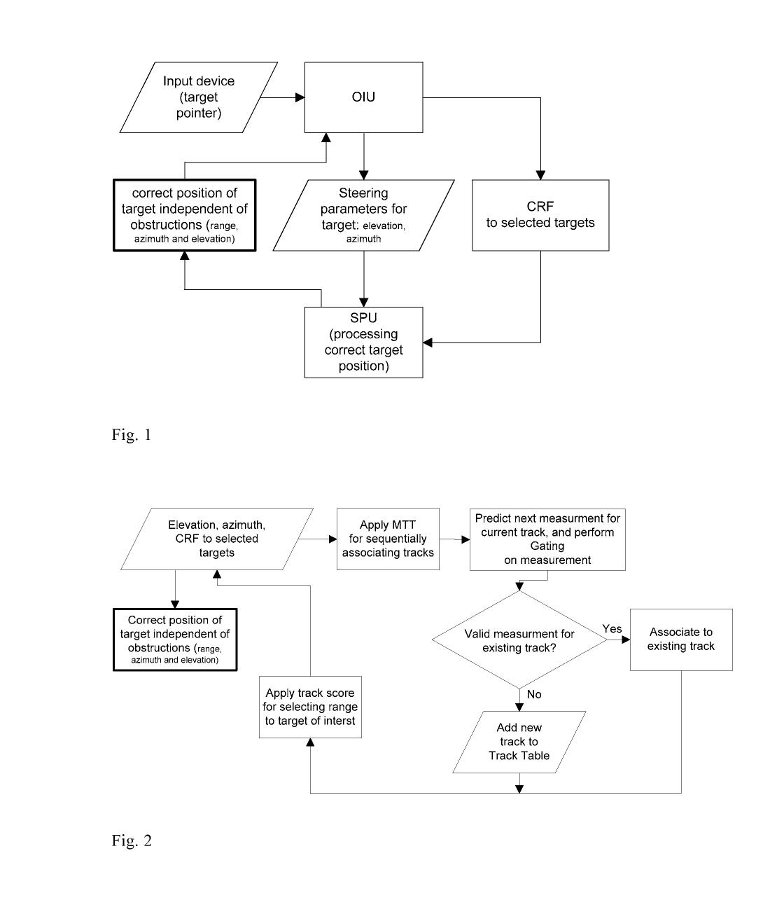

The invention will now be described with reference to the figures where: FIG. 1 is a flow chart showing the different components comprised in the system, and

FIG. 2 is a flow chart showing the method performed by the signal processing unit.

The present invention describes a method and system for using a conventional laser system for a Continuous Range Finder (CRF) even when the laser beam is directed at an obstruction in front of or behind a target.

This requires that the raw output from the laser is processed such that range measurements corresponding to line-of-sight obstructions, or to the background behind the target are removed. The present invention describes a method and system for doing this.

As mentioned earlier a problem with conventional LRF occurs when the laser beam misses a target. This may be due to obstructions of free sight between the laser beam and a target. Another reason for missing a target is that an operator will not always be able to aim and keep the laser beam continuously on the target when performing continues laser range readings. In one moment the laser can hit a target and in a next moment the laser may hit the background. The laser beam may also partly cover the target and the background. In such cases the output from the LRF may return the range to both the target and the background. These two ranges will have the same time stamp, but only one range is the correct range to the target.

The present invention relates to an improvement of a conventional LRF system used as a CRF to an operator desired target.

This requires that the raw output from the CRF is processed such that range measurements corresponding to line-of-sight obstructions, or to the background behind the target are removed.

The invention describes a method and system for presenting continuous range measurements to the target independently of whether the laser beam in the laser range finder is pointing on the target at all time, resulting in range measurements to a target with a high degree of accuracy.

The invention will now be explained with reference to the figures.

FIG. 1 is a flow chart showing an overview of the different components comprised in the inventive system. On operator of the system is operating an input device connected to an Operator Interface Unit (OIU). The input device is used for controlling and aiming the laser beam in the CRF at a target of interest. The input device can be a joystick steered by the operator, a helmet to be used on the operators head furnished with positioning sensors, or other more sophisticated techniques, coupled to a general steering mechanism for controlling the pointing direction of the LRF.

Range data from the CRF is input to a Signal Processing Unit (SPU) that is also receiving information related to the angular position of a target being aimed at.

In one embodiment of the invention the angular position is calculated from the variance to the commanded angular velocity in order to decide if the same target is being aimed at.

In another embodiment the angular position is calculated from angular rates of the aiming axis.

Input to the angular rates is received from the control grip of the operator.

Based on the input data to the SPU correct and continuous position data (range, azimuth and elevation) of the target is presented through OIU independently of temporal obstructions. Said different components can be located on a static or moving platform.

The inventive system comprises: a laser range finder directing a laser beam at the target; signal processing means for continuously receiving range measurements to the target and measurement means for measuring of angular position of said laser beam;

processing means for processing said range and angular position measurements and for applying multiple target tracking on said measurements, and
an operator interface unit for presenting continuous range measurements to the target independently of whether the laser beam in the laser range finder is pointing on the target at all time.

FIG. 2 is a flow chart showing the method performed by the signal processing unit (SPU).

The inventive method comprises several steps. The laser beam of a CRF is directed at the target and raw data of range measurements to the target are continuously received in the SPU together with measurements of angular position (based on angular velocity) of said laser beam. The target aimed at can be moving, stand still or behave according to a combination of these.

The SPU processes said range and angular position measurements by applying Multiple Target Tracking (MTT) for sorting and sequentially associating range measurements to tracks in a track table.

MTT is a method used in radar tracking applications to track several targets. MTT is based on a track table that maintains all tracks originated from the targets. Maintenance of the track table is performed by a data association method. In MTT, data association is the function that performs gating, observation-to-track association and track maintenance.

Gating is used as a screening mechanism to determine which observations of range measurement are valid candidates to update existing tracks or if the range measurement is to start a new track. Observation-to-track association takes observation-to-track pairings and determines which observation-to-track assignments that will be made. Track maintenance is a function that initiates new tracks from unassigned measurements, and deletes tracks not assigned to any measurements. Data association, together with a functionality to predict the next measurements (typically by using a Kalman filter), and the track table, constitutes MTT.

MTT will handle all range measurements from the LRF. The range measurements from the MTT are sorted into tracks and placed in a track table. A specific track for the target is selected based on information about which sequence of measurements that behave as expected for the target. As said a measured range is either associated to an existing track or initiating a new track.

In one embodiment of the LRF, range predictions can be used to track targets which measurements are lost due to obstacles between the platform and the target. It will then be possible to continue to track the target even if measurements are lost for a period.

A next predicted measurement is continuously calculated based on measured range history. A Kalman filter can be used for this purpose.

Gating is then used on each predicted range measurement for associating each LRF measurement to an existing track or adding a new track in the track table. Gating is performed by creating a gate around a predicted range measurement.

Different strategies exist for calculating reasonable gate sizes. One strategy is to increase or decrease the gate based on hard coded tuning of values. Another strategy for calculation the size of a gate is to use the resulting predicted values and innovation matrix from the Kalman filter. The innovation matrix is used for making the gate dynamic by weighting the deviation between measurement and prediction.

The gate of a track is increased if a track is not associated with a measurement, and it is decreased if the track is associated with the measurement. In this way prediction uncertainties and velocity change of the target is taken into account.

Track score is applied for selecting the track that most likely represents the target, and where the track score is dependent on measurements of the angular position of said laser beam. The track with the highest score is chosen to represent the target aimed at. Track score is thus a measure of how well the track is consistent with the model of the target movements. The purpose of the track score is to get a measure of the track quality and use it to choose which track that is most likely to be the target of interest. The track in the track table having the maximum track score is considered to be the target of interest.

A simple method for calculating a track score is to add a number to the score each time a track experiences a measurement association, and subtract a number when the track is not updated.

A preferred method for calculating a track score is to use a Track Score Function (TSF). This evaluates an alternative track formation hypothesis by a probabilistic expression. All aspects of the data association problem, except for the signal related terms, are included. The TSF consists of the likelihood function for the observation model and a probability density function evaluated with the received range measurement. During the evaluation it is assumed that the false alarm hypothesis is correct. A uniform distribution over the measurement volume for false returns is assumed. The desired track score behavior is used to design an upper threshold for this.

A forgetting factor is used to limit the track scores. This will emphasize the newest part of the track sequence making it easier to switch between two existing tracks.

A track is deleted from the track table after a pre-set number of range measurements being associated to other tracks.

Azimuth and elevation measurements returned from the OIU are constantly detected. When a user is tracking a target the azimuth and elevation measurements from the OIU will have small variance due to constant angular change rate. When the user changes target, the variance of the angular movement will become large because the angular change rate suddenly changes. By calculating the variance of a sliding window of a number of samples, one gets a measure of how much the angular rate vary and it becomes easier to detect abnormal angular movements.

All tracks in a track table are deleted when it is detected that the angular change rate of the laser beam changes, indicating that an operator is aiming at a new target. Tracks are however not deleted when it is detected that the angular change rate is above a certain value. This may occur if the operator unintentionally and suddenly changes the aiming of the laser beam of a CRF while aiming at a target. Sudden movements of a vehicle where the CRF is mounted can also cause a sudden high angular change rate.

Operational target switching will be detected if joystick measurement variance exceeds the maximum variance limit, which can be set empirically.

The inventive method and system will thus produce an output from the SPU that represents the correct range and angular position to a target of interest independently of obstructions or due to an operator missing a target for a while.

1. A method for obtaining continuous range measurements to a target aimed at by using a laser range finder, and where the method is independent of whether a laser beam in the laser range finder is reflected off the target at all times, said method comprises the following steps:
directing the laser beam at the target;
continuously receiving range measurements to the target together with measurements of angular position of said laser beam;
processing said range and angular position measurements by applying multiple target tracking, and
presenting continuous range measurements to the target independently of whether the laser beam in the laser range finder is pointing on the target at all time.

2. A method according to claim 1, where the range measurements from multiple target tracking are sorted into tracks in a track table, and a specific track for the target is selected based on information about which sequence of measurements that behave as expected for the target.

3. A method according to claim 2, where a range measurement is either associated to an existing track or initiating a new track.

4. A method according to claim 2, where gating is used for associating a range measurement to a specific track.

5. A method according to claim 2, where track score is applied for selecting the track that most likely represents the target, and where the track score is dependent on measurements of the angular position of said laser beam.

6. A method according to claim 2, where all tracks in a track table are deleted when it is detected that the angular change rate of the laser beam changes, indicating that an operator is aiming at a new target.

7. A method according to claim 3, where a track is deleted from the track table after a pre-set number of range measurements being associated to other tracks.

8. A system for obtaining continuous range measurements to a target aimed at by using a laser range finder, and where the system is independent of whether a laser beam in the laser range finder is reflected off the target at all time, said system comprises:
a laser range finder directing the laser beam at the target;
signal processing means for continuously receiving range measurements to the target and measurement means for measuring of angular position of said laser beam;
processing means for processing said range and angular position measurements and for applying multiple target tracking on said measurements, and
an operator interface unit for presenting continuous range measurements to the target independently of whether the laser beam in the laser range finder is pointing on the target at all time.

9. A system according to claim 8, further comprising means for sorting the range measurements from multiple target tracking into tracks in a track table, and selecting means for selecting a specific track for the target based on information about which sequence of measurements that behave as expected for the target.
